(19) United States
(12) Patent Application Publication
(10) Pub. No.: US 2026/0313043 A1
(43) Pub. Date: Oct. 8, 2026

(54) ELECTRONIC DEVICE, SYSTEM, AND CLOUD SERVICE PROVIDING METHOD THEREOF

(71) Applicant: Samsung Electronics Co., Ltd., Suwon-si (KR)

(72) Inventors: Youngpil LEE, Suwon-si (KR); Seonghyun KIM, Suwon-si (KR); Gwangseong CHOI, Suwon-si (KR); Woosuk CHOI, Suwon-si (KR); Wonjin CHOI, Suwon-si (KR)

(21) Appl. No.: 19/681,806

(22) Filed: May 19, 2026

Related U.S. Application Data
(63) Continuation of application No. PCT/KR2024/021099, filed on Dec. 26, 2024.

(30) Foreign Application Priority Data
Jan. 17, 2024 (KR) 10-2024-0007108
Feb. 8, 2024 (KR) 10-2024-0019968

(51) Int. Cl. H04L 67/60; H04L 67/75

(52) U.S. Cl. CPC H04L 67/60; H04L 67/75

(57) ABSTRACT

An electronic device includes a communication circuit configured to receive and transmit a signal, memory, including one or more storage media, storing one or more computer programs and at least one application, and one or more processors communicatively coupled to the communication circuit and the memory, wherein the one or more computer programs include computer-executable instructions that, when executed by the one or more processors individually or collectively, cause the electronic device to, based on a request for a cloud service associated with a first application received from an external device through the communication circuit, execute the first application corresponding to the request for the cloud service among the at least one application, while executing the first application, recognize a request for an action associated with a second application from the first application, and based on a determination that target information included in the request for the action corresponds to target information related to a pre-designated deep link, transmit the request for the action to the external device.

### CROSS-REFERENCE TO RELATED APPLICATION(S)

This application is a continuation application, claiming priority under 35 U.S.C. § 365(c), of an International application No. PCT/KR2024/021099, filed on Dec. 26, 2024, which is based on and claims the benefit of a Korean patent application number 10-2024-0007108, filed on Jan. 17, 2024, in the Ministry of Intellectual Property (MOIP), and of a Korean patent application number 10-2024-0019968, filed on Feb. 8, 2024, in the Ministry of Intellectual Property (MOIP), the disclosure of each of which is incorporated by reference herein in its entirety.

### BACKGROUND

### 1. Field

The relates to a technology for performing operations of an application using a cloud service.

### 2. Description of Related Art

A cloud service refers to a service in which an application and/or data are stored in an external device (hereinafter a server device) providing the cloud service connected through a network, and the application and/or the data are used by a client device as needed through the external device. For example, among applications, there may exist an application that requires interworking with another application and/or another web service. When an application is to be interworked with another application through the cloud service, an interworking operation between the applications may be performed in the server device providing the cloud service. For example, when the interworking operation between the applications is performed in the server device, another application to be interworked with an application being executed in the server device or user information required for the interworking needs to be pre-stored in the server device. In this case, the client device needs to provide user information to the server device in advance, or an application customized for the server device needs to be stored in advance in the server device, and data used in an application included in the client device (e.g., a user) may not be smoothly interworked in the server device.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a technology for performing operations of an application using a cloud service.

Additional aspects will be set forth in part in the description which follows and, in part, will be apparent from the description, or may be learned by practice of the presented embodiments.

In accordance with an aspect of the disclosure, an electronic device is provided. The electronic device includes a communication circuit configured to receive and transmit a signal, memory, including one or more storage media, storing one or more computer programs and at least one application, and one or more processors communicatively coupled to the communication circuit and the memory, wherein the one or more computer programs include computer-executable instructions that, when executed by the one or more processors individually or collectively, cause the electronic device to, based on a request for a cloud service associated with a first application received from an external device through the communication circuit, execute the first application corresponding to the request for the cloud service among the at least one application, while executing the first application, recognize a request for an action associated with a second application from the first application, and based on a determination that target information included in the request for the action corresponds to target information related to a pre-designated deep link, transmit the request for the action to the external device.

In accordance with another aspect of the disclosure, an electronic device is provided. The electronic device includes a display, a communication circuit configured to receive and transmit a signal, memory, including one or more storage media, storing one or more computer programs and at least one application, and one or more processors communicatively coupled to the display, the communication circuit, and the memory, wherein the one or more computer programs include computer-executable instructions that, when executed by the one or more processors individually or collectively, cause the electronic device to request a cloud service associated with a first application from an external device through the communication circuit, receive, from the external device, cloud service data related to the first application executed by the external device, display an execution screen of the first application through the display based on the cloud service data, receive, from the external device, a request for an action associated with a second application from the first application while displaying the execution screen of the first application, execute the second application corresponding to the request for the action among the at least one application, and perform the action through the second application.

In accordance with another aspect of the disclosure, a method of an electronic device for providing a cloud service is provided. The method includes based on a request for a cloud service associated with a first application received from an external device, executing the first application corresponding to the request for the cloud service, while executing the first application, recognizing a request for an action associated with a second application from the first application, and based on a determination that target information included in the request for the action corresponds to target information related to a pre-designated deep link, transmitting the request for the action to the external device.

In accordance with another aspect of the disclosure, a method of an electronic device for providing a cloud service is provided. The method includes requesting a cloud service associated with a first application from an external device, receiving cloud service data associated with the first application executed by the external device from the external device, displaying an execution screen of the first application through a display of the electronic device based on the cloud service data, receiving, from the external device, a request for an action associated with a second application from the first application while displaying the execution screen of the first application, executing the second application corresponding to the request for the action among at least one application stored on the electronic device, and performing the action through the second application.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include, based on a request for a cloud service associated with a first application received from an external device, executing the first application corresponding to the request for the cloud service, while executing the first application, recognizing a request for an action associated with a second application from the first application, and based on a determination that target information included in the request for the action corresponds to target information related to a pre-designated deep link, transmitting the request for the action to the external device.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include requesting a cloud service associated with a first application from an external device, receiving cloud service data associated with the first application executed by the external device from the external device, displaying an execution screen of the first application through a display of the electronic device based on the cloud service data, receiving, from the external device, a request for an action associated with a second application from the first application while displaying the execution screen of the first application, executing the second application corresponding to the request for the action among at least one application stored on the electronic device, and performing the action through the second application.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device according to an embodiment of the disclosure;

FIG. 2 is a block diagram of an electronic device according to an embodiment of the disclosure;

FIG. 3 is a block diagram of a system providing a cloud service according to an embodiment of the disclosure;

FIG. 4 is a flowchart of a cloud service providing method of a system according to an embodiment of the disclosure;

FIG. 5 is a flowchart of a cloud service providing method of an electronic device according to an embodiment of the disclosure;

FIG. 6 is a flowchart of a cloud service providing method of an electronic device according to an embodiment of the disclosure;

FIG. 7 is a flowchart of a cloud service providing method of an electronic device according to an embodiment of the disclosure;

FIG. 8 is a flowchart of a cloud service providing method of an electronic device according to an embodiment of the disclosure;

FIG. 9 is of an electronic device according to an embodiment of the disclosure;

FIGS. 10A, 10B, and 10C illustrate examples of execution screens of an application through a cloud service provided by an electronic device according to various embodiments of the disclosure; and

FIG. 11 illustrates an electronic device in a network environment according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

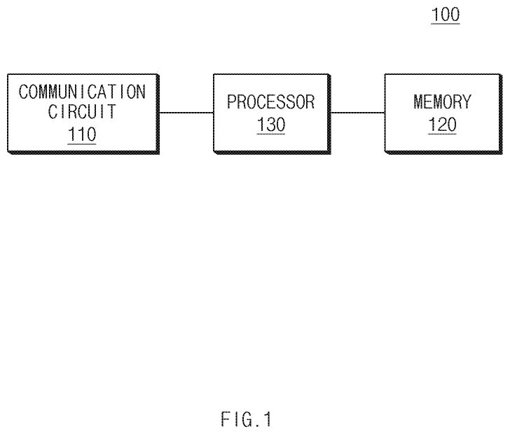

FIG. 1 is a block diagram of an electronic device according to an embodiment of the disclosure.

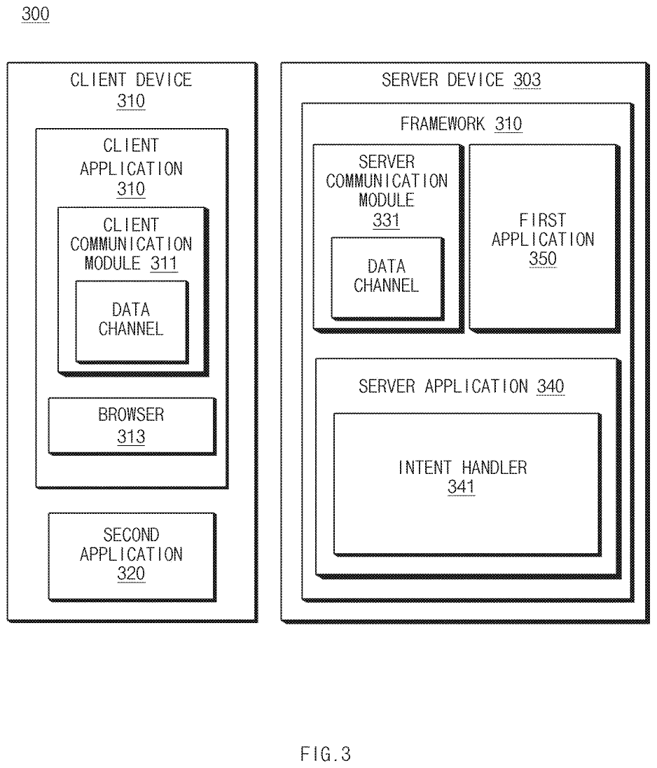

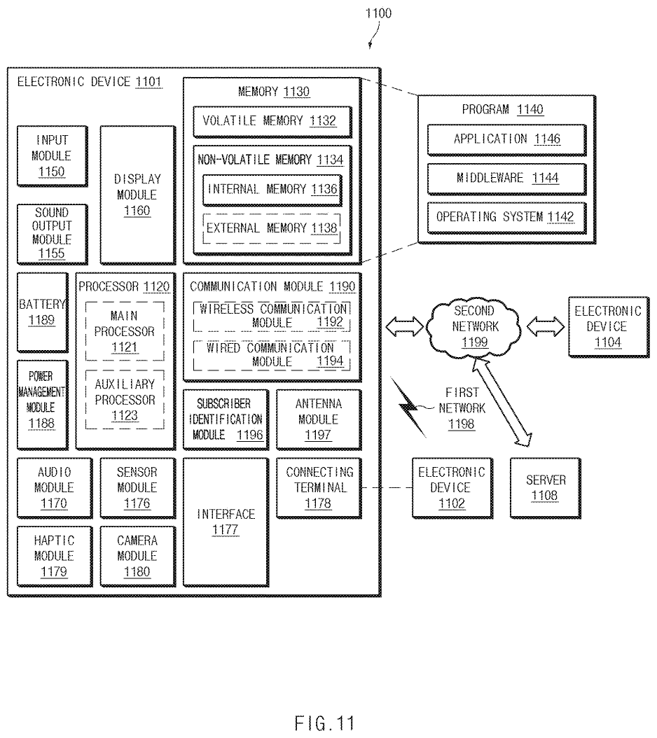

According to an embodiment, an electronic device 100 (e.g., a server device 303 in FIG. 3 or an electronic device 101 or a server 1108 in FIG. 11) may include a communication circuit 110 (e.g., a server communication module 331 in FIG. 3 or a communication module 1190), a memory 120 (e.g., a memory 1130 in FIG. 11), and at least one processor 130 (e.g., a processor 1120 in FIG. 11).

According to an embodiment, the communication circuit 110 may transmit and receive information and/or data to and from an external device (e.g., a client device) and/or an external server. For example, the communication circuit 110 may transmit cloud service data (e.g., execution data of an application corresponding to a user request) to the external device. The communication circuit 110 may transmit, to the external device, a request for an action from an application, and/or may receive redirect information related to an application being executed from the external device.

According to an embodiment, the memory 120 may store instructions that, when executed by at least one processor 130, control operations of the electronic device 100. According to an embodiment, the instructions may be stored in one memory 120 or in a plurality of memories 120. The memory 120 may store, at least temporarily, information and/or data related to operations of the electronic device 100. For example, the memory 120 may store setting information associated with an application (e.g., a manifest) and/or pre-designated target information (e.g., scheme information).

According to an embodiment, the processor 130 may execute a first application corresponding to a request for a cloud service based on a request for the cloud service associated with the first application received from the external device through the communication circuit 110. For example, the processor 130 may execute the first application among a plurality of applications stored in the memory 120.

According to an embodiment, the processor 130 may recognize a request for an action associated with another application from the first application during execution of the first application. According to an embodiment, the request for the action may include at least one of target information corresponding to the action (e.g., a scheme) or uniform resource identifier (URI) information (or uniform resource locator (URL) information) related to the action. For example, the request for the action may include an intent (e.g., an implicit intent) executed (or requested) by the first application. For example, the intent may be a messaging object for requesting a specific action from an application being executed or another application. For example, an application may notify an operating system (e.g., an Android operating system) of an action and/or an activity to be performed through the intent. For example, the intent may include an explicit intent and an implicit intent. The explicit intent may include information explicitly specifying a component (e.g., an activity, a service, and/or a receiver) to be executed, and the implicit intent may include information implicitly specifying a component (e.g., action information, category information, and data information). The data information may include host information (e.g., domain information), a scheme, and/or URI information related to the action.

According to an embodiment, the processor 130 may transmit, to the external device through the communication circuit 110, the request for the action based on a determination that target information (e.g., a scheme) included in the request for the action (e.g., the implicit intent) corresponds to target information (e.g., a scheme) related to a pre-designated deep link. For example, the deep link may refer to a link configured to reach a specific web page. The specific web page may be provided through a designated application or may be provided through a browser. For example, the deep link may refer to a link that, when a user selects a URI and/or a URL in a web site or an application in a mobile environment, causes another application corresponding to the URI and/or the URI to be executed so as to perform a corresponding operation, or an operation of moving to a web page corresponding to the URI and/or the URI to be performed. For example, the processor 130 may store target information related to the pre-designated deep link. For example, the processor 130 may register a deep link-related scheme in setting information (e.g., manifest information) associated with an application. When a scheme included in an intent requested from the first application corresponds to the deep link-related scheme registered in the manifest, the processor 130 may transmit data of the intent to the external device.

According to an embodiment, the processor 130 may transmit data of the intent to the external device through the communication circuit 110, thereby allowing an intent of the first application providing the cloud service to be performed by the external device. For example, the processor 130 may allow the external device to perform an action corresponding to an intent executed by the first application.

According to an embodiment, the processor 130 may receive redirect information corresponding to the request for the action from the external device through the communication circuit 110. According to an embodiment, the redirect information may be generated through an application different from the first application included in the external device. For example, the processor 130 may receive the redirect information from the external device as a response to the request for the action (e.g., the intent) requested from the first application providing the cloud service. For example, when the intent indicates an action of outputting a specific web view (e.g., a web page), the processor 130 may receive redirect information returned to the first application based on the specific web page and user input from the external device. For example, when the intent of the first application is a login of a specific web page, the redirect information may include user authentication information according to a login success.

According to an embodiment, the processor 130 may provide the redirect information to the first application based on a determination that the redirect information is related to the first application. For example, the processor 130 may determine whether the redirect information is related to the first application based on setting information (e.g., manifest information) associated with the first application. For example, the setting information (e.g., a manifest) may include designated target information (e.g., scheme information) related to a redirect. When a scheme included in the redirect information corresponds to a scheme related to a redirect included in the manifest, the processor 130 may provide the redirect information to the first application.

According to an embodiment, the processor 130 may perform an action of the first application based at least in part on the redirect information. For example, the processor 130 may invoke or provide an activity of the first application corresponding to the redirect information based at least in part on the redirect information. For example, the processor 130 may interwork user account information through the first application and a second application (or a specific web page) based on the redirect information.

According to an embodiment, operations described as being performed by the processor 130 may be performed by at least one processor 130. For example, each of the above-described operations may be performed by the same or different one processor 130, and/or may be performed by at least some of a plurality of processors 130. For example, at least some of the above-described operations may be performed by a first processor 130, and at least some of the remainder may be performed by a second processor 130. According to an embodiment, the processor 130 may include a circuit such as a central processing unit (CPU), a microprocessor unit (MPU), an application processor (AP), a communication processor (CP), a system on chip (SoC), and/or an Integrated Circuit (IC).

According to various embodiments, the configuration of the electronic device 100 is not limited to that described in FIG. 1, and at least one component may be omitted or at least one component (e.g., at least one of components of a server device 303 in FIG. 3 or an electronic device 1101 in FIG. 11) may be added.

During provision of the cloud service, when interworking with another application and/or another service is required, the electronic device 100 (e.g., a server device) according to an embodiment may allow the interworking to be performed in the external device (e.g., the client device) without performing the interworking in the electronic device 100. The electronic device 100 according to an embodiment may increase user convenience in providing the cloud service by allowing interworking between applications and user information to be utilized by the external device without receiving or storing in advance the user information and/or an application stored in the external device, and may provide a user of the external device with a user experience substantially identical to executing the application in the external device itself rather than the cloud service.

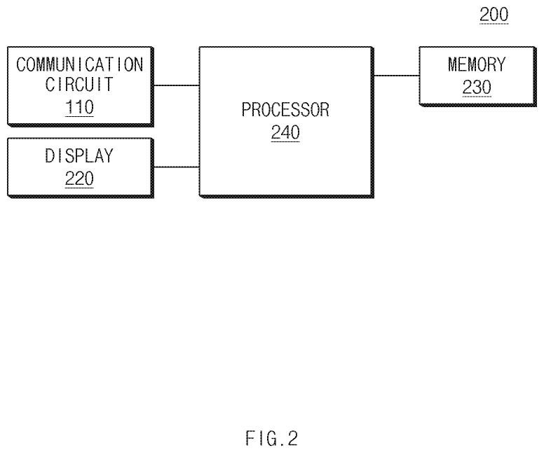

FIG. 2 is a block diagram of an electronic device according to an embodiment of the disclosure.

According to an embodiment, an electronic device 200 (e.g., a client device 301 in FIG. 3 or an electronic device 1101 in FIG. 11) may include a communication circuit 210 (e.g., a client communication module 311 in FIG. 3 or a communication module 1190 in FIG. 11), a display 220 (e.g., a display module 1160 in FIG. 11), a memory 230 (e.g., a memory 1130 in FIG. 11), and at least one processor 240 (e.g., a processor 1120 in FIG. 11).

According to an embodiment, the communication circuit 210 may transmit and receive information and/or data to and from an external device (e.g., a server device). For example, the communication circuit 210 may receive, from the external device, cloud service data (e.g., execution data of an application corresponding to a user request). The communication circuit 210 may receive, from the external device, a request for an action from an application, and/or may transmit, to the external device, redirect information generated as a result of performing the received request for the action.

According to an embodiment, the display 220 may visually output data. For example, the display 220 may output an execution screen of an application through a cloud service, a web view (e.g., a web page) corresponding to the request for the action received from the external device, and/or an execution screen of an application executed in the electronic device 200.

According to an embodiment, the memory 230 may store instructions that, when executed by at least one processor 240, control operations of the electronic device 200. According to an embodiment, the instructions may be stored in one memory 230 or in a plurality of memories 230. The memory 230 may store, at least temporarily, information and/or data related to operations of the electronic device 200. For example, the memory 230 may store setting information associated with an application (e.g., a manifest) and/or pre-designated target information (e.g., scheme information).

According to an embodiment, the processor 240 may request, through the communication circuit 210, a cloud service associated with a first application from the external device. According to an embodiment, the processor 240 may receive, through the communication circuit 210, cloud service data associated with the first application executed by the external device from the external device. For example, the cloud service data may include execution data of the first application.

According to an embodiment, the processor 240 may display, based on the cloud service data, an execution screen of the first application through the display 220. According to an embodiment, the execution screen of the first application may include an indication indicating that the first application is being executed based on the cloud service.

According to an embodiment, the processor 240 may receive, while displaying the execution screen of the first application, a request for an action associated with another application from the first application from the external device. According to an embodiment, the request for the action may include at least one of target information corresponding to the action (e.g., a scheme) or uniform resource identifier (URI) information (or uniform resource locator (URL) information) related to the action. For example, the request for the action may include an intent (e.g., an implicit intent) executed (or requested) by the first application.

According to an embodiment, the processor 240 may execute a second application corresponding to the request for the action among at least one application included in the electronic device 200. The second application may include at least one pre-stored application and/or at least one third-party provided application in the electronic device 200. The second application may be an application not stored in the external device. According to an embodiment, the processor 240 may determine the second application among at least one application included in the electronic device 200 based on target information (e.g., the scheme) included in the request for the action (e.g., the intent). According to an embodiment, based on recognizing a plurality of applications corresponding to target information included in the request for the action among the at least one application, the processor 240 may provide a user interface (e.g., an application selection (chooser) screen) for determining the second application among the plurality of applications. The processor 240 may determine the second application based on a user input received through the user interface.

According to an embodiment, the processor 240 may perform the action corresponding to the request from the first application through the second application. For example, the processor 240 may invoke or provide an activity corresponding to the request from the first application through the second application. According to an embodiment, the processor 240 may display, through the display 220, a result of execution of the action. For example, when the action is to perform a specific function through the second application or to download a specific application, the processor 240 may output a result of performing the specific function or a result of downloading through the display 220.

According to an embodiment, the processor 240 may receive a user input associated with execution of the action. For example, the processor 240 may output a web view (e.g., a web page) associated with execution of the action. For example, the web view may include a login screen of a designated web site or application related to the action. The processor 240 may receive a user input for login while displaying the web view.

According to an embodiment, the processor 240 may generate redirect information associated with the request for the action through the second application based at least in part on the user input. For example, when login succeeds in response to the user input, the processor 240 may obtain redirect information including user authentication information through the second application (or a web site).

According to an embodiment, the processor 240 may transmit the redirect information to the external device.

According to an embodiment, operations described as being performed by the processor 240 may be performed by at least one processor 240. For example, each of the above-described operations may be performed by the same or different one processor 240, and/or may be performed by at least some of a plurality of processors 240. For example, at least some of the above-described operations may be performed by a first processor 240, and at least some of the remainder may be performed by a second processor 240. According to an embodiment, the processor 240 may include a circuit such as a central processing unit (CPU), a microprocessor unit (MPU), an application processor (AP), a communication processor (CP), a system on chip (SoC), and/or an Integrated Circuit (IC).

According to various embodiments, the configuration of the electronic device 200 is not limited to that described in FIG. 1, and at least one component may be omitted or at least one component (e.g., at least one of components of a client device 301 in FIG. 3 or an electronic device 1101 in FIG. 11) may be added.

When interworking with another application and/or another service is required while using the cloud service, the electronic device 200 (e.g., the client device) according to an embodiment may perform the interworking in the electronic device 200 without performing the interworking in a cloud environment (e.g., the external device (e.g., the server device)). The electronic device 200 according to an embodiment may increase user convenience in providing the cloud service by using interworking between applications and user information without transmitting the user information and/or an application stored in the electronic device to the external device, and may provide a user with a user experience substantially identical to executing the application in the electronic device 200 itself.

For example, in providing the cloud service, when interworking (e.g., a deep link) between applications is performed in the server device (e.g., a cloud device), the server device may need to receive user data in advance from the client device (e.g., a user terminal), or may need to store in advance an application customized for the server device. During provision of the cloud service, when interworking with another application and/or another service is required, the electronic device (e.g., the client device and/or the server device) and/or a system according to an embodiment may perform the interworking in the client device without performing the interworking in the cloud environment (e.g., the server device). The electronic device and/or the system according to an embodiment may increase user convenience in providing the cloud service by using interworking between applications and user information without transmitting the user information and/or an application stored in the client device to the server device, and may provide a user with a user experience substantially identical to executing the application in the client device itself.

The electronic device (e.g., the server device) according to an embodiment of the disclosure may include a communication circuit, a memory storing at least one application, and at least one processor. According to an embodiment, the memory may store instructions that, when executed by at least one processor, control operations of the electronic device.

According to an embodiment, the instructions may, when executed by the at least one processor, cause the electronic device to execute, based on the request for the cloud service associated with the first application received from the external device through the communication circuit, the first application corresponding to the request for the cloud service among the at least one application.

According to an embodiment, the instructions may, when executed by the at least one processor, cause the electronic device to recognize a request for an action associated with another application from the first application during execution of the first application.

According to an embodiment, the instructions may, when executed by the at least one processor, cause the electronic device to transmit the request for the action to the external device based on a determination that target information included in the request for the action corresponds to target information related to a pre-designated deep link.

The instructions may, when executed by the at least one processor, cause the electronic device to receive, from the external device through the communication circuit, redirect information corresponding to the request for the action.

The instructions may, when executed by the at least one processor, cause the electronic device to provide the redirect information to the first application based on a determination that the redirect information is related to the first application.

The instructions may, when executed by the at least one processor, cause the electronic device to perform an action of the first application based at least in part on the redirect information.

According to an embodiment, the redirect information may be generated through an application different from the first application included in the external device.

The instructions may, when executed by the at least one processor, cause the electronic device to determine whether the redirect information is associated with the first application based on whether target information included in the redirect information corresponds to preset setting information associated with the first application.

According to an embodiment, the request for the action may include at least one of the target information corresponding to the action or uniform resource identifier (URI) information related to the action.

The electronic device (e.g., the client device) according to an embodiment of the disclosure may include a display, a communication circuit, at least one processor, and a memory including at least one application. According to an embodiment, the memory may store instructions that, when executed by at least one processor, control operations of the electronic device.

According to an embodiment, the instructions may, when executed by the at least one processor, cause the electronic device to request the cloud service associated with the first application from the external device through the communication circuit.

According to an embodiment, the instructions may, when executed by the at least one processor, cause the electronic device to receive the cloud service data associated with the first application executed by the external device from the external device.

According to an embodiment, the instructions may, when executed by the at least one processor, cause the electronic device to display an execution screen of the first application through the display based on the cloud service data.

According to an embodiment, the instructions may, when executed by the at least one processor, cause the electronic device to receive, while displaying the execution screen of the first application, a request for an action associated with another application from the first application from the external device.

According to an embodiment, the instructions may, when executed by the at least one processor, cause the electronic device to execute the second application corresponding to the request for the action among the at least one application.

According to an embodiment, the instructions may, when executed by the at least one processor, cause the electronic device to perform the action through the second application.

According to an embodiment, the instructions may, when executed by the at least one electronic device, cause the electronic device to receive a user input associated with execution of the action.

According to an embodiment, the instructions may, when executed by the at least one electronic device, cause the electronic device to generate the redirect information associated with the request for the action through the second application based at least in part on the user input.

According to an embodiment, the instructions may, when executed by the at least one electronic device, cause the electronic device to transmit the redirect information to the external device through the communication circuit.

According to an embodiment, the instructions may, when executed by the at least one electronic device, cause the electronic device to display a result of execution of the action through the display.

According to an embodiment, the instructions may, when executed by the at least one electronic device, cause the electronic device to determine the second application among the at least one application based on the target information included in the request for the action.

According to an embodiment, the instructions may, when executed by the at least one electronic device, cause the electronic device to provide a user interface for determining the second application among a plurality of applications based on recognizing the plurality of applications corresponding to the target information included in the request for the action among the at least one application.

According to an embodiment, the instructions may, when executed by the at least one electronic device, cause the electronic device to determine the second application based on a user input received through the user interface.

According to an embodiment, the execution screen of the first application may include an indication indicating that the first application is being executed based on the cloud service.

FIG. 3 is a block diagram of a system providing a cloud service according to an embodiment of the disclosure.

According to an embodiment, a system 300 may include a client device 301 (e.g., the electronic device 200 in FIG. 2 or an electronic device 1101 in FIG. 11) and a server device 303 (e.g., the electronic device 100 in FIG. 1, an electronic device 1101 in FIG. 11, or a server 1108).

According to an embodiment, the client device 301 may include a client application 310 and at least one second application 320.

The client application 310 may be an application pre-stored in the client device 301. The client application 310 may control an operation (e.g., data transmission and reception with the server device 303) of the client device 301. For example, the client application 310 may control an overall operation of the client device 301 under an operating system (e.g., an Android operating system) of the client device 301. For example, the client application 310 may receive, from the server device 303, information on a request for an action (e.g., an intent) from a first application 350 being executed, output, through a browser 313, a screen corresponding to the request for the action (e.g., the intent), or execute a second application 320 to perform a function and/or an action of the second application 320 corresponding to the request for the action, and/or invoke or provide an activity of the second application 320. When redirect information (e.g., URL information requiring redirection) is generated (occurs) while executing the browser 313, the client application 310 may transmit the redirect information to the server device 303.

According to an embodiment, the client application 310 may include a client communication module 311 and a browser 313. According to an embodiment, the client communication module 311 may perform peer-to-peer communication with the server device 303 (e.g., a server communication module 331). For example, the client communication module 311 may form a data channel with the server device 303 (e.g., the server communication module 331) using a designated protocol and/or an application programming interface (API), and may transmit and receive data (e.g., a data stream and/or a text message) to and from the server device 303 through the data channel. For example, the designated protocol and/or the application programming interface (API) may include web real time communication (WebRTC) and/or socket (e.g., web socket) communication, but is not limited thereto.

According to an embodiment, the browser 313, as an internal browser 313 of the client application 310, may provide a web view (e.g., an Internet screen) based on uniform resource identifier (URI) and/or uniform resource locator (URL) information included in a request for an action (e.g., an intent).

According to an embodiment, the second application 320 may include at least one application stored in the client device 301 except the client application 310. For example, the second application 320 may include at least one application pre-stored (e.g., embedded when the client device 301 is manufactured) in the client device 301. The second application 320 may include at least one application provided from a third party (e.g., a service provider). For example, a third-party provided application 320 may include at least one application downloaded by a client user from outside through a network. For example, the second application 320 may include at least one application that is the same as or corresponds to the first application 350. For example, the second application 320 may include a game application, but is not limited thereto.

According to an embodiment, the server device 303 may, according to an embodiment, include a cloud container. The server device 303 (e.g., the cloud container) may include a framework 308 (e.g., an Android framework 308).

According to an embodiment, the framework 308 may include a server communication module 331, at least one first application 350, and a server application 340.

According to an embodiment, the server communication module 331 may perform peer-to-peer communication with the client device 301 (e.g., the client communication module 311). For example, the server communication module 331 may form a data channel with the client device 301 (e.g., the client communication module 311) using a designated protocol and/or an application programming interface (API), and may transmit and receive data (e.g., a data stream and/or a text message) to and from the client device 301 through the data channel. For example, the designated protocol and/or the application programming interface (API) may include web real time communication (WebRTC), but is not limited thereto.

According to an embodiment, the first application 350 may include at least one application stored in the server device 303 except the server application 340. For example, the first application 350 may include at least one application pre-stored in the server device 303 (e.g., initially embedded in the server device 303). The first application 350 may include at least one application provided from a third party (e.g., a service provider) other than the server device 303 (e.g., a cloud service provider). For example, the first application 350 may be executed in response to a cloud service request of the client device 301. For example, the first application 350 may also be stored in the client device 301, but is not limited thereto. For example, the first application 350 may include a game application, but is not limited thereto.

The server application 340 may be an application pre-stored in the server device 303. The server application 340 may control an operation (e.g., data transmission and reception with the client device 301) of the server device 303. For example, the server application 340 may control an overall operation of the server device 303 under an operating system (e.g., the Android operating system) of the server device 303.

According to an embodiment, the server application 340 may include an intent handler 341. For example, the intent handler 341 may include an activity executed by a request for an action (e.g., an intent) requested from an application being executed in the Android operating system. According to an embodiment, the intent handler 341 may control operations related to a request for an action requested from an application. For example, the intent handler 341 may receive a request for an action (e.g., an intent) requested from the first application. The intent handler 341 may transmit information related to the request for the action to the client device 301. The intent handler 341 may receive redirect information from the client device 301 (e.g., the second application 320). The intent handler 341 may provide the received redirect information to the first application 350.

According to various embodiments, the configuration of the client device 301 is not limited to that described in FIG. 3, and at least one component may be omitted or at least one component (e.g., at least one of components of the electronic device 200 in FIG. 2 and/or components of the electronic device 1101 in FIG. 11) may be added. The configuration of the server device 303 is not limited to that described in FIG. 3, and at least one component may be omitted or at least one component (e.g., at least one of components of the electronic device 100 in FIG. 1 and/or components of the electronic device 1101 in FIG. 11) may be added. According to an embodiment, operations of the server device 303 (e.g., the server application 340) described in FIG. 3 may be performed by the processor 130 in FIG. 1, and operations of the client device 301 (e.g., the client application 310) may be performed by the processor 240 in FIG. 2.

During provision of a cloud service, when interworking with another application and/or another service is required, the system 300 according to an embodiment may allow the interworking to be performed in the client device 301 without performing the interworking in the server device 303. The system 300 according to an embodiment may increase user convenience in providing the cloud service by performing an interworking operation between applications in the client device 301 and/or allowing user information stored in the client device 301 to be used without transmitting in advance the user information and/or an application stored in the client device 301 to the server device 303 or storing the user information and/or the application in advance in the server device 303, and may provide a user of the client device 301 with a user experience substantially identical or similar to executing an application in the client device 301 itself without using the server device 303. According to embodiments of the disclosure, the client device may interact with an application in the server device (e.g., a cloud device) without being limited by a situation or an environment (e.g., performance and/or storage space of the client device) of the client device. According to embodiments of the disclosure, an event suitable for a mobile environment, such as a deep link-related event (e.g., displaying a web page or an intent action in an Android environment) occurring in an application in the server device, may be received and processed in the client device, and a result of the processing may be transmitted again to the application in the server device, thereby enabling smooth interaction between the user and the application through the cloud service.

According to embodiments of the disclosure, infrastructure required for a virtual environment may be installed in a lightweight manner. Instead of installing in advance the second application 320 included in the client device 301 in the virtual environment (server device), by transmitting necessary events through the client device and directly processing the necessary events or allowing installation of an application when necessary, it is possible to reduce a need to install in advance necessary applications in the server device in consideration of all scenarios when constructing infrastructure of the virtual environment.

According to embodiments of the disclosure, by performing deep link-related operations in the client device rather than in the server device, security of user information may be improved. For example, it is possible to solve a problem in which the user's personal information (e.g., login information) may remain in a cache or the like of the server device in a reusable virtual environment (e.g., the server device) and thus the user's personal information may be exposed, and it is possible to prevent the user from providing personal information to the server device. In addition, according to embodiments of the disclosure, by transmitting data in an encrypted state between an application of the client device and an application of the server device, it is possible to reduce a possibility of leakage of personal information.

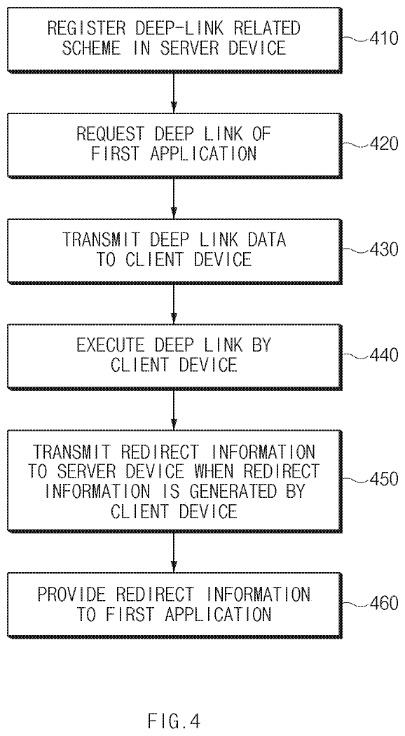

FIG. 4 is a flowchart of a cloud service providing method of a system according to an embodiment of the disclosure. For example, the method of FIG. 4 is described on the assumption that the system 300 in FIG. 3 performs operations in the Android operating system, but is not limited thereto.

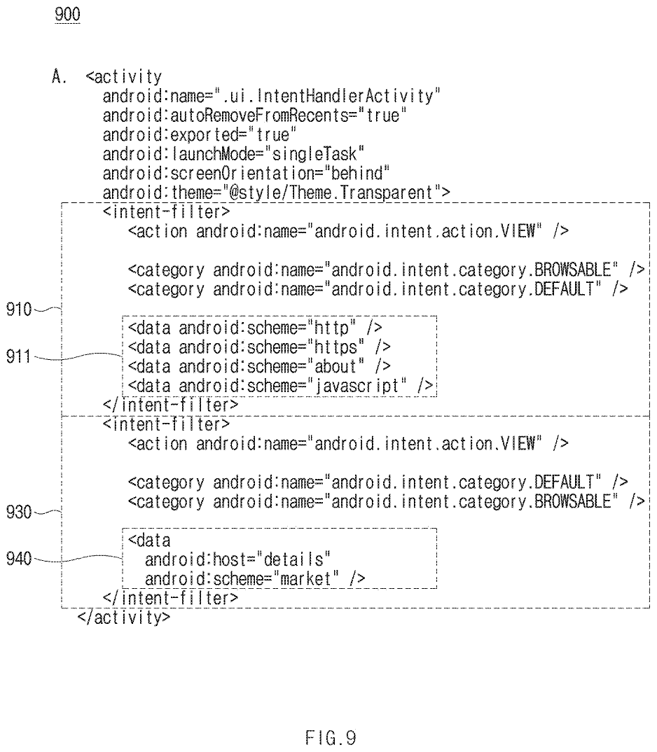

According to an embodiment, in operation 410, the server device 303 (e.g., the electronic device 100 in FIG. 1, or the electronic device 1101 or the server 1108 in FIG. 11) may register deep link-related target information (e.g., a scheme). For example, the server device 303 may register a deep link-related scheme in setting information (e.g., manifest information) associated with an application (e.g., setting information 900 in FIG. 9). For example, the server device 303 may register the deep link-related scheme (e.g., http, https, about, javascript, market, samsungapps, tel, or the like) in an intent filter in the manifest information.

According to an embodiment, in operation 420, the server device 303 may execute, among at least one first application 350, a first application corresponding to a cloud service request of the client device 301 (e.g., the electronic device 200 in FIG. 2 or the electronic device 1101 in FIG. 11). The server device 303 may recognize a request to execute a deep link of the first application. For example, the server device 303 may recognize a request for an action (e.g., an intent) of the first application associated with another application. The server device 303 may determine, based on the registered deep link-related target information, whether the intent of the first application is an intent related to the deep link. For example, when the first application executes the intent related to the deep link, the server application 340 (e.g., the intent handler 341) may be executed. The server application 340 (e.g., the intent handler 341) may recognize a type of the intent related to the deep link. For example, the intent may include target information (e.g., a scheme). For example, the intent handler 341 may recognize the type of the intent based on the scheme included in the intent. For example, the type of the intent may include a web type or an intent type. For example, when the intent includes a scheme (e.g., http, https) corresponding to a deep link uniform resource identifier (URI) and/or uniform resource locator (URL) capable of being opened through the browser 313, the intent handler 341 may determine the type of the intent as the web type, and when the intent includes another scheme (e.g., market, samsungapps, tel) other than the browser 313, the intent handler 341 may determine the type of the intent as the intent type.

According to an embodiment, in operation 430, the server device 303 may transmit deep link data to the client device 301. For example, the server application 340 (e.g., the intent handler 341) may transmit data of the intent executed by the first application to the client device 301 through the server communication module 331. According to an embodiment, when the data of the intent is transmitted, the intent handler 341 may transmit information on the type of the intent together to the client device 301.

For example, when the intent is of the web type (e.g., the intent includes an https scheme), the intent handler 341 may transmit, to the client device 301, data of the intent such as:

{
“type”:“web_url”,
“url”:“https//fac*.com/v13.0/dialog/pauth/?client_id=319553”
}

As another example, when the intent is of the intent type (e.g., the intent includes a market scheme), the intent handler 341 may transmit, to the client device 301, data of the intent such as:

{
“type”:“intent_url”,
“url”:“market://details?id-com.togamesinc/evony”
}

According to an embodiment, in operation 440, the client device 301 (e.g., the client application 310) may execute a deep link. For example, the client device 301 may receive data of the intent from the server device 303 through the client communication module 311. The client device 301 (e.g., the client application 310) may execute a deep link corresponding to the intent based on the received data of the intent. According to an embodiment, the client device 301 may execute the deep link based on a type of the intent. For example, the client device 301 may execute the deep link based on information on the type of the intent received from the server device 303, or may recognize the type of the intent by recognizing scheme information included in the intent based on the data of the intent received from the server and execute the deep link. For example, when the intent is of the web type, the client application 310 may output a web page corresponding to the intent through the browser 313. When the intent is of the intent type, the client application 310 may deliver the intent to an application (e.g., the second application 320) capable of executing the intent. For example, in the Android environment, the client device 301 may execute an intent (e.g., an implicit intent) corresponding to the received data of the intent, and an application capable of processing the intent in the client device 301 may be executed. For example, when there is a plurality of applications capable of processing the intent in the client device 301, the client device 301 may provide a user interface for selecting one of the plurality of applications according to a user input. For example, when there is no application capable of processing the intent in the client device 301, the client device 301 may provide a user interface for inducing installation of a related application.

According to an embodiment, in operation 450, when redirect information is generated by the client device 301, the client device 301 may transmit the redirect information to the server device 303. For example, while the browser 313 outputs a web page corresponding to the web type intent, the browser 313 may obtain the redirect information based on a user input. For example, while the browser 313 outputs a login-related web page, when login is completed based on a user input, the browser 313 may obtain redirect information (e.g., a redirect URL) capable of being received and processed by the first application 350. For example, the redirect information may include a URL of a specific scheme including user authentication information. The client device 301 may transmit the obtained redirect information to the server device 303 through the client communication module 311.

According to an embodiment, in operation 460, the server device 303 may provide the redirect information to the first application. For example, the intent handler 341 may receive the redirect information from the client device 301 through the server communication module 331. The intent handler 341 may determine whether to transmit the redirect information to the first application based on setting information (e.g., manifest information) associated with the first application. For example, the first application and the manifest information may include, in the intent filter, URL information for a designated scheme related to a redirect (e.g., “fbconnect://”, “fleetcommand://loggedin/?code”, “mygms-com.my.lts://”, or “scopelyid://loggedin”). For example, when target information (e.g., a scheme) included in the redirect information corresponds to target information (e.g., a scheme) related to a redirect registered in the setting information, the intent handler 341 may provide the redirect information to the first application. For example, the intent handler 341 may transmit an intent including the redirect information to the first application. The first application may receive the intent including the redirect information based on host information and/or scheme information of the setting information (manifest) associated with the first application, which is registered in the intent filter. The first application may perform the action corresponding to the intent based on the redirect information.

During provision of a cloud service, when interworking with another application and/or another service is required, the system 300 according to an embodiment may allow the interworking to be performed in the client device 301 without performing the interworking in the server device 303. The system 300 according to an embodiment may increase user convenience in providing the cloud service by performing an interworking operation between applications in the client device 301 and/or allowing user information stored in the client device 301 to be used without transmitting in advance the user information and/or an application stored in the client device 301 to the server device 303 or storing the user information and/or the application in advance in the server device 303, and may provide a user of the client device 301 with a user experience substantially identical or similar to executing an application in the client device 301 itself without using the server device 303.

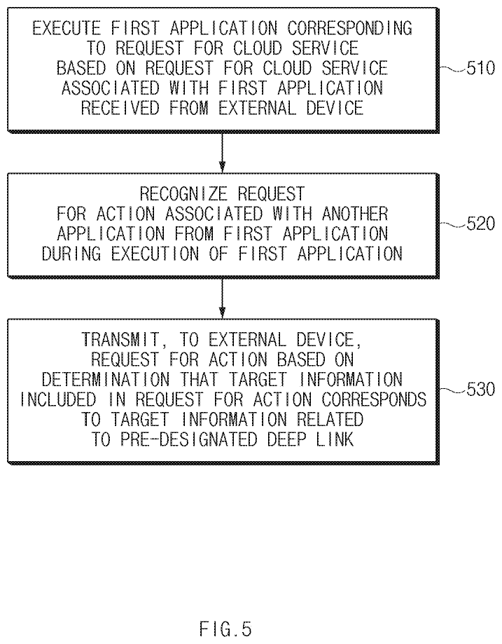

FIG. 5 is a flowchart of a cloud service providing method of an electronic device according to an embodiment of the disclosure.

According to an embodiment, in operation 510, an electronic device (e.g., the electronic device 100 in FIG. 1, the server device 303 in FIG. 3, or the electronic device 1101 or the server 1108 in FIG. 11) may execute, based on a request for a cloud service associated with a first application received from an external device (e.g., the electronic device 200 in FIG. 2, the client device 301 in FIG. 3, or the electronic device 1101 in FIG. 11), the first application corresponding to the request for the cloud service. For example, the electronic device may execute the first application among a plurality of applications stored in the memory.

According to an embodiment, in operation 520, the electronic device may recognize a request for an action associated with another application from the first application during execution of the first application. According to an embodiment, the request for the action may include at least one of target information corresponding to the action (e.g., a scheme) or uniform resource identifier (URI) information (or uniform resource locator (URL) information) related to the action. For example, the request for the action may include an intent (e.g., an implicit intent) executed (or requested) by the first application. For example, the intent may be a messaging object for requesting a specific action from an application being executed or another application. For example, an application may notify an operating system (e.g., an Android operating system) of an action and/or an activity to be performed through the intent. For example, the intent may include an explicit intent and an implicit intent. The explicit intent may include information explicitly specifying a component (e.g., an activity, a service, and/or a receiver) to be executed, and the implicit intent may include information implicitly specifying a component (e.g., action information, category information, and data information). The data information may include host information (e.g., domain information), a scheme, and/or URI information related to the action.

According to an embodiment, in operation 530, the electronic device may transmit, to the external device, the request for the action based on a determination that target information (e.g., a scheme) included in the request for the action (e.g., the implicit intent) corresponds to target information (e.g., a scheme) related to a pre-designated deep link. For example, the electronic device may store target information related to the pre-designated deep link. For example, the electronic device may register a deep link-related scheme in setting information (e.g., manifest information) associated with an application. When a scheme included in an intent requested from the first application corresponds to the deep link-related scheme registered in the manifest, the electronic device may transmit data of the intent to the external device.

According to an embodiment, the electronic device may transmit data of the intent to the external device, thereby allowing an intent of the first application providing the cloud service to be performed by the external device. For example, the electronic device may allow the external device to perform an action corresponding to an intent executed by the first application.

During provision of the cloud service, when interworking with another application and/or another service is required, the cloud service providing method of an electronic device according to an embodiment may allow the interworking to be performed in the external device (e.g., the client device) without performing the interworking in the electronic device. The cloud service providing method of an electronic device according to an embodiment may increase user convenience in providing the cloud service by allowing interworking between applications and user information to be utilized by the external device without receiving or storing in advance the user information and/or an application stored in the external device by the electronic device, and may provide a user of the external device with a user experience substantially identical to executing the application in the external device itself rather than the cloud service.

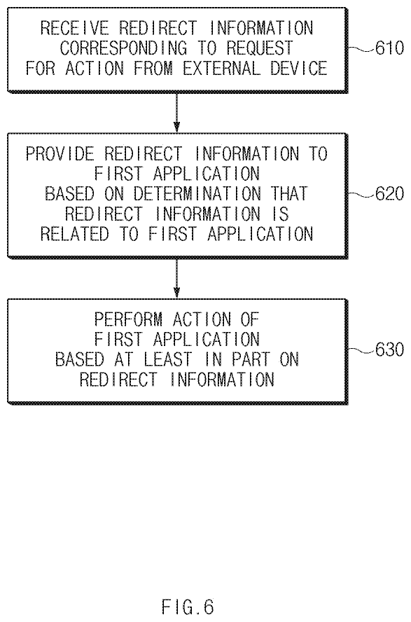

FIG. 6 is a flowchart of a cloud service providing method of an electronic device according to an embodiment of the disclosure. For example, operations of FIG. 6 may be performed after the operations of FIG. 5, but are not limited thereto.

According to an embodiment, in operation 610, an electronic device (e.g., the electronic device 100 in FIG. 1, the server device 303 in FIG. 3, or the electronic device 1101 or the server 1108 in FIG. 11) may receive redirect information corresponding to a request for an action from an external device (e.g., the electronic device 200 in FIG. 2, the client device 301 in FIG. 3, or the electronic device 1101 in FIG. 11). According to an embodiment, the redirect information may be generated through an application different from the first application included in the external device. For example, the electronic device may receive the redirect information from the external device as a response to the request for the action (e.g., the intent) requested from the first application providing the cloud service. For example, when the intent indicates an action of outputting a specific web view (e.g., a web page), the electronic device may receive redirect information returned to the first application based on the specific web page and user input from the external device. For example, when the intent of the first application is a login of a specific web page, the redirect information may include user authentication information according to a login success.

According to an embodiment, in operation 620, the electronic device may provide the redirect information to the first application based on a determination that the redirect information is related to the first application. For example, the electronic device may determine whether the redirect information is related to the first application based on setting information (e.g., manifest information) related to the first application. For example, the setting information (e.g., a manifest) may include designated target information (e.g., scheme information) related to a redirect. When a scheme included in the redirect information corresponds to a scheme related to a redirect included in the manifest, the electronic device may provide the redirect information to the first application.

According to an embodiment, in operation 630, the electronic device may perform an action of the first application based at least in part on the redirect information. For example, the electronic device may invoke or provide an activity of the first application corresponding to the redirect information based at least in part on the redirect information. For example, the electronic device may interwork user account information through the first application and a second application (or a specific web page) based on the redirect information.

During provision of the cloud service, when interworking with another application and/or another service is required, the cloud service providing method of an electronic device according to an embodiment may allow the interworking to be performed in the external device (e.g., the client device) without performing the interworking in the electronic device. The cloud service providing method of an electronic device according to an embodiment may increase user convenience in providing the cloud service by allowing interworking between applications and user information to be utilized by the external device without receiving or storing in advance the user information and/or an application stored in the external device by the electronic device, and may provide a user of the external device with a user experience substantially identical to executing the application in the external device itself rather than the cloud service.

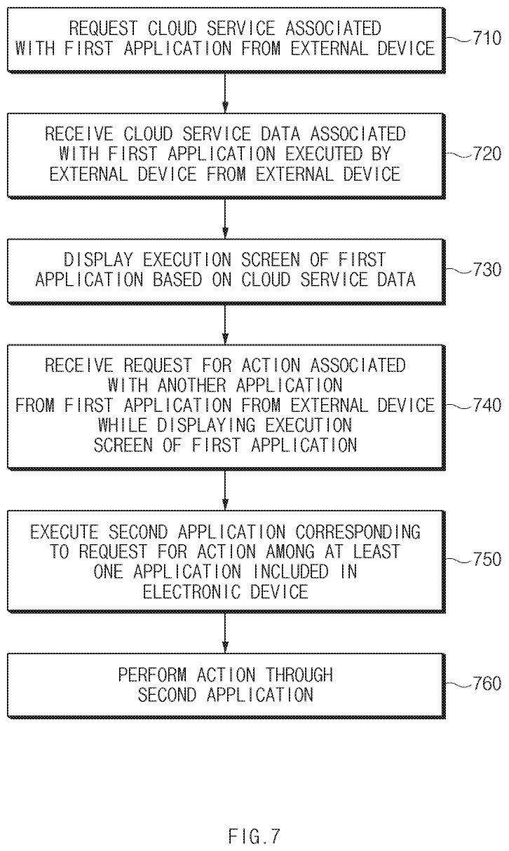

FIG. 7 is a flowchart of a cloud service providing method of an electronic device according to an embodiment of the disclosure.

According to an embodiment, in operation 710, an electronic device (e.g., the electronic device 200 in FIG. 2, the client device 301 in FIG. 3, or the electronic device 1101 in FIG. 11) may request, from an external device (e.g., the electronic device 100 in FIG. 1, the server device 303 in FIG. 3, or the electronic device 1101 or the server 1108 in FIG. 11), a cloud service associated with a first application.

According to an embodiment, in operation 720, the electronic device may receive, from the external device, cloud service data associated with the first application executed by the external device. For example, the cloud service data may include execution data of the first application.

According to an embodiment, in operation 730, the electronic device may display an execution screen of the first application through a display of the electronic device based on the cloud service data. According to an embodiment, the execution screen of the first application may include an indication indicating that the first application is being executed based on the cloud service.

According to an embodiment, in operation 740, the electronic device may receive, while displaying the execution screen of the first application, a request for an action associated with another application from the first application from the external device. According to an embodiment, the request for the action may include at least one of target information corresponding to the action (e.g., a scheme) or uniform resource identifier (URI) information (or uniform resource locator (URL) information) related to the action. For example, the request for the action may include an intent (e.g., an implicit intent) executed (or requested) by the first application.

According to an embodiment, in operation 750, the electronic device may execute a second application corresponding to the request for the action among at least one application included in the electronic device. The second application may include a third-party provided application. The second application may be an application not stored in the external device. According to an embodiment, the electronic device may determine the second application among at least one application included in the electronic device based on target information (e.g., the scheme) included in the request for the action (e.g., the intent). According to an embodiment, based on recognizing a plurality of applications corresponding to target information included in the request for the action among the at least one application, the electronic device may provide a user interface (e.g., an application selection (chooser) screen) for determining the second application among the plurality of applications. The electronic device may determine the second application based on a user input received through the user interface.

According to an embodiment, in operation 760, the electronic device may perform the action corresponding to the request from the first application through the second application. For example, the electronic device may invoke or provide an activity corresponding to the request from the first application through the second application. According to an embodiment, the electronic device may display a result of execution of the action through the display. For example, when the action is to perform a specific function through the second application or to download a specific application, the electronic device may output a result of performing the specific function or a result of downloading through the display.

The cloud service providing method of an electronic device according to an embodiment may, when interworking with another application and/or another service is required while the cloud service is used, perform the interworking in the external device without performing the interworking in the cloud environment (e.g., the external device (e.g., the server device)). The cloud service providing method of an electronic device according to an embodiment may increase user convenience in providing the cloud service by using interworking between applications and user information without transmitting the user information and/or an application stored in the electronic device to the external device, and may provide a user with a user experience substantially identical to executing the application in the electronic device itself.

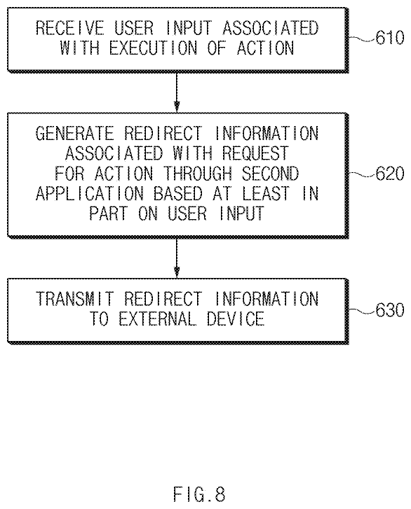

FIG. 8 is a flowchart of a cloud service providing method of an electronic device according to an embodiment of the disclosure. For example, FIG. 8 may be performed as at least a part of operation 760 in FIG. 7, but is not limited thereto.

According to an embodiment, in operation 810, an electronic device (e.g., the electronic device 200 in FIG. 2, the client device 301 in FIG. 3, or the electronic device 1101 in FIG. 11) may receive a user input associated with execution of an action. For example, the electronic device may output a web view (e.g., a web page) associated with execution of the action. For example, the web view may include a login screen of a designated web site or application related to the action. The electronic device may receive a user input for login while displaying the web view.

According to an embodiment, in operation 820, the electronic device may generate redirect information associated with the request for the action through the second application based at least in part on the user input. For example, when login succeeds in response to the user input, the electronic device may obtain redirect information including user authentication information through the second application (or a web site).

According to an embodiment, in operation 830, the electronic device may transmit the redirect information to an external device (e.g., the electronic device 100 in FIG. 1, the server device 303 in FIG. 3, or the electronic device 1101 or the server 1108 in FIG. 11).

The cloud service providing method of an electronic device according to an embodiment may, when interworking with another application and/or another service is required while the cloud service is used, perform the interworking in the external device without performing the interworking in the cloud environment (e.g., the external device (e.g., the server device)). The cloud service providing method of an electronic device according to an embodiment may increase user convenience in providing the cloud service by using interworking between applications and user information without transmitting the user information and/or an application stored in the electronic device to the external device, and may provide a user with a user experience substantially identical to executing the application in the electronic device itself.

FIG. 9 illustrates an example of setting information of an electronic device according to an embodiment of the disclosure.

According to an embodiment, an electronic device (e.g., a server device) (e.g., the electronic device 100 in FIG. 1, the server device 303 in FIG. 3, or the electronic device 1101 or the server 1108 in FIG. 11) may store setting information 900 related to an application. Hereinafter, as an example of the setting information 900, manifest information associated with an application in an Android environment is described, but the embodiments of the disclosure are not limited thereto.

For example, the manifest information may include filter information 910 and 930 (e.g., intent filters) related to an action (e.g., an intent) of an application including at least one piece of target information 911 or 940 (e.g., scheme information).

For example, the filter information 910 and 930 (e.g., the intent filters) may designate (or register) at least one piece of target information 911 or 940 (e.g., a scheme). For example, referring to FIG. 9, a first intent filter 910 may designate schemes 911 of “http”, “https”, “about”, and “javascript”, and a second intent filter 930 may designate a “market” scheme 940.

According to an embodiment, when a request for an action (e.g., an intent) associated with another application from an application is recognized, the electronic device may perform a deep link operation based on whether a scheme included in the request for the action is a scheme designated in the setting information. For example, when scheme information included in a request for an action (intent) requested from an application being executed corresponds to “http”, “https”, “about”, “javascript”, or “market”, the electronic device may transmit data of the intent to an external device (e.g., the client device) and perform the deep link operation.

According to an embodiment, the setting information may further include target information (e.g., a scheme) related to a redirect. For example, when redirect information (e.g., a redirect URL) is received from an external device (e.g., the electronic device 200 in FIG. 2, the client device 301 in FIG. 3, or the electronic device 1101 in FIG. 11), the electronic device may determine whether target information (e.g., a scheme) included in the redirect information corresponds to target information designated in the setting information 900 (e.g., the manifest information). When target information included in the redirect information corresponds to the target information 911 and 940 designated in the setting information 900, the electronic device may provide the redirect information to an application being executed.

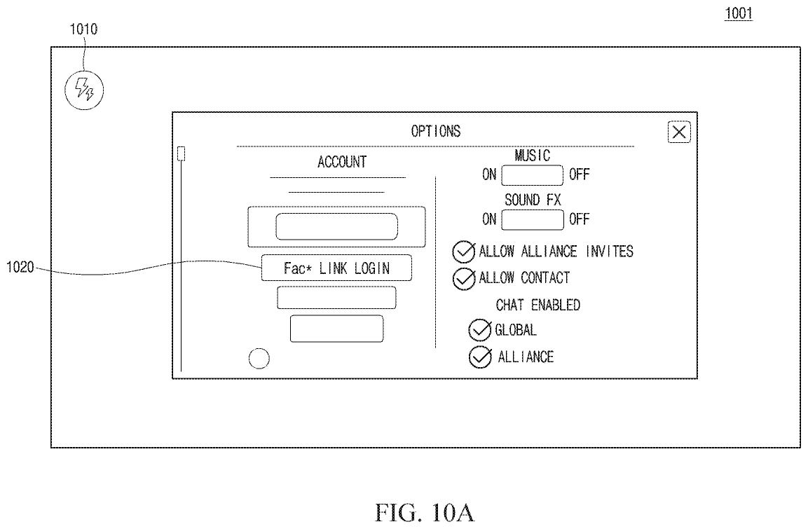

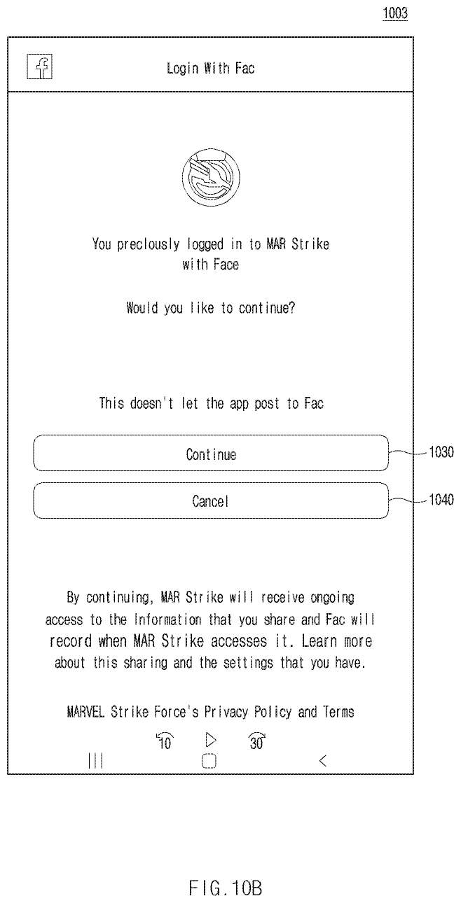

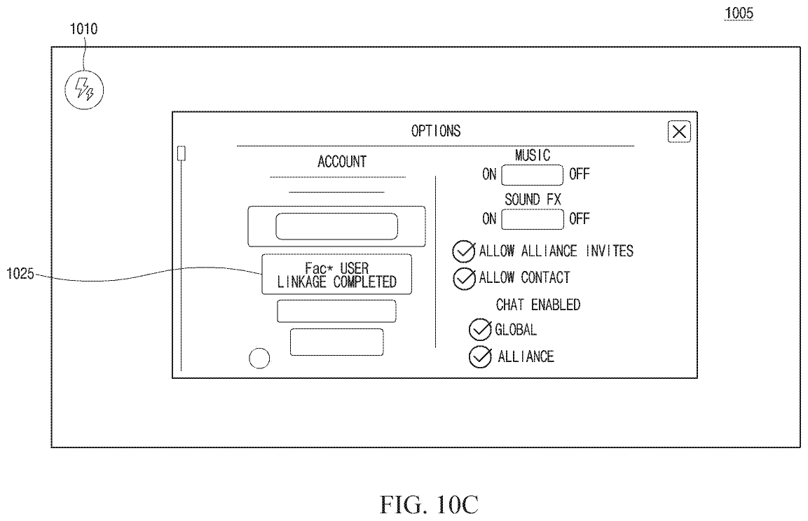

FIGS. 10A to 10C illustrate examples of execution screens of an application through a cloud service provided by an electronic device according to various embodiments of the disclosure.

According to an embodiment, referring to FIG. 10A, a first screen 1001 illustrates a screen in which a first application (e.g., a game application) is executed through a cloud service on a client device (e.g., the electronic device 200 in FIG. 2, the client device 301 in FIG. 3, or the electronic device 1101 in FIG. 11). For example, when the client device requests the cloud service for the first application, a server device (e.g., the electronic device 100 in FIG. 1, the server device 303 in FIG. 3, or the electronic device 1101 or the server 1108 in FIG. 11) may execute the first application stored in the server device and provide cloud data associated with execution of the first application to the client device in real time. The client device may output an execution screen (the first screen 1001) of the first application based on the cloud data. According to an embodiment, the first screen 1001 may include an indication 1010 indicating that the first application is being executed based on the cloud service. According to an embodiment, while the first application is being executed, the server device may transmit, to the client device, a request for an action (e.g., an intent related to a deep link) associated with another application, which is requested from the first application. The client device may output the first screen 1001 related to account login based on the request for the action received from the server device. The first screen 1001 may include a first user interface 1020 for linking with a user account of a second application. For example, based on a user input to the first user interface 1020, the client device may output a second screen 1003.

According to an embodiment, referring to FIG. 10B, the second screen 1003 illustrates a screen in which the second application (e.g., an SNS application or a browser application) is executed on the client device. For example, the client device may execute the second application included in the client device in response to the request for the action received from the server device. According to an embodiment, the second application may not be stored in the server device. For example, the client device may execute the second application capable of interworking with the first application and output the second screen 1003. The client device may receive a user input (e.g., a user input for login) for the second application. For example, the second screen 1003 may include a second user interface 1030 for approving login and a third user interface 1040 for rejecting login. The client device may log in to a user account associated with the second application based on a user input received through the second user interface 1030. For example, when login succeeds, the client device may obtain redirect information (e.g., a redirect uniform resource locator (URL)) from the second application. For example, the redirect information may be generated through login of the second application. The client device may transmit the redirect information to the server device.

According to an embodiment, referring to FIG. 10C, a third screen 1005 illustrates a screen in which the first application (e.g., the game application) is executed through the cloud service on the client device. For example, the server device may perform an action of the first application based on the redirect information received from the client device. For example, the server device may invoke an activity (e.g., the third screen 1005) of the first application corresponding to the redirect information based on the redirect information. For example, the server device may interwork the first application with the second application based on the redirect information and transmit, to the client device, cloud data related to the third screen 1005 indicating that the interworking has been completed. The client device may output an execution screen (the third screen 1005) of the first application indicating that interworking with the second application has been completed based on the cloud data received from the server device. For example, the third screen 1005 may include a fourth user interface 1025 indicating that the first application has logged in and/or interworked through a user account of the second application. According to an embodiment, the third screen 1005 may include an indication 1010 indicating that the first application is being executed based on the cloud service.

According to an embodiment, during provision of the cloud service, the client device and the server device may interwork the first application executed on the server device with the second application stored in the client device. For example, the client device may perform the action by executing the second application stored in the client device based on the request for the action (e.g., an intent) received from the server device, and when redirect information is generated, may provide the generated redirect information to the server device (e.g., the first application of the server device), and the server device may perform the action (or an activity) of the first application based on the redirect information. In this way, the client device and the server device may provide the cloud service by utilizing, as it is, a manner of executing or interworking the first application and/or the second application on a local device (e.g., the client device) without the cloud service. Accordingly, the server device may perform an interworking operation between applications through the client device during provision of the cloud service without receiving or storing an application (e.g., the second application) and/or user information stored in the client device.

A cloud service providing method of an electronic device (e.g., a server device) according to an embodiment of the disclosure may include executing, based on a request for a cloud service associated with a first application received from an external device, the first application corresponding to the request for the cloud service.

According to an embodiment, the method may include recognizing, while executing the first application, a request for an action associated with another application from the first application.

According to an embodiment, the method may include transmitting, based on a determination that target information included in the request for the action corresponds to target information related to a pre-designated deep link, the request for the action to the external device.

According to an embodiment, the method may include receiving redirect information corresponding to the request for the action from the external device.

According to an embodiment, the method may include providing, based on a determination that the redirect information is related to the first application, the redirect information to the first application.

According to an embodiment, the method may further include performing an action of the first application based at least in part on the redirect information.

According to an embodiment, the redirect information may be generated through an application different from the first application included in the external device.

According to an embodiment, the providing of the redirect information to the first application may include determining whether the redirect information is related to the first application based on whether target information included in the redirect information corresponds to predetermined setting information associated with the first application.

According to an embodiment, the request for the action may include at least one of the target information corresponding to the action or uniform resource identifier (URI) information related to the action.

A cloud service providing method of an electronic device (e.g., a client device) according to an embodiment of the disclosure may include requesting a cloud service associated with a first application from an external device.

According to an embodiment, the method may include receiving cloud service data associated with the first application executed by the external device from the external device.

According to an embodiment, the method may include displaying an execution screen of the first application through a display based on the cloud service data.

According to an embodiment, the method may include receiving, from the external device, a request for an action associated with another application from the first application while displaying the execution screen of the first application.

According to an embodiment, the method may include executing a second application corresponding to the request for the action among the at least one application.

According to an embodiment, the method may include performing the action through the second application.

According to an embodiment, the method may include receiving a user input associated with the execution of the action.

According to an embodiment, the method may include generating redirect information associated with the request for the action through the second application based at least in part on the user input.

According to an embodiment, the method may include transmitting the redirect information to the external device through the communication circuit.

According to an embodiment, the method may include displaying an execution result of the action through the display.

According to an embodiment, the method may include determining the second application among the at least one application based on the target information included in the request for the action.

According to an embodiment, the determining of the second application may include providing a user interface for determining the second application among the plurality of applications based on recognizing a plurality of applications corresponding to the target information included in the request for the action among the at least one application.

According to an embodiment, the determining of the second application may include determining the second application based on a user input received through the user interface.

According to an embodiment, the execution screen of the first application may include an indication indicating that the first application is being executed based on the cloud service.

In the cloud service providing method according to an embodiment, during provision of the cloud service, when interworking with another application and/or another service is required, the interworking may be performed in the client device without performing the interworking in the cloud environment (e.g., the server device)). In the cloud service providing method according to an embodiment, user convenience may be increased in providing the cloud service by using interworking between applications and user information without transmitting stored user information and/or a stored application to the server device, and a user experience substantially identical to executing the application in the client device itself may be provided to a user.

FIG. 11 is a block diagram illustrating an electronic device 1101 in a network environment 1100 according to an embodiment of the disclosure. Referring to FIG. 11, the electronic device 1101 in the network environment 1100 may communicate with an electronic device 1102 via a first network 1198 (e.g., a short-range wireless communication network), or at least one of an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120, memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module(SIM) 1196, or an antenna module 1197. In some embodiments, at least one of the components (e.g., the connecting terminal 1178) may be omitted from the electronic device 1101, or one or more other components may be added in the electronic device 1101. In some embodiments, some of the components (e.g., the sensor module 1176, the camera module 1180, or the antenna module 1197) may be implemented as a single component (e.g., the display module 1160).

The processor 1120 may execute, for example, software (e.g., a program 1140) to control at least one other component (e.g., a hardware or software component) of the electronic device 1101 coupled with the processor 1120, and may perform various data processing or computation. According to one embodiment, as at least part of the data processing or computation, the processor 1120 may store a command or data received from another component (e.g., the sensor module 1176 or the communication module 1190) in volatile memory 1132, process the command or the data stored in the volatile memory 1132, and store resulting data in non-volatile memory 1134. According to an embodiment, the processor 1120 may include a main processor 1121 (e.g., a central processing unit (CPU) or an application processor (AP)), or an auxiliary processor 1123 (e.g., a graphics processing unit (GPU), a neural processing unit (NPU), an image signal processor (ISP), a sensor hub processor, or a communication processor (CP)) that is operable independently from, or in conjunction with, the main processor 1121. For example, when the electronic device 1101 includes the main processor 1121 and the auxiliary processor 1123, the auxiliary processor 1123 may be adapted to consume less power than the main processor 1121, or to be specific to a specified function. The auxiliary processor 1123 may be implemented as separate from, or as part of the main processor 1121.

The auxiliary processor 1123 may control at least some of functions or states related to at least one component (e.g., the display module 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). According to an embodiment, the auxiliary processor 1123 (e.g., an image signal processor or a communication processor) may be implemented as part of another component (e.g., the camera module 1180 or the communication module 1190) functionally related to the auxiliary processor 1123. According to an embodiment, the auxiliary processor 1123 (e.g., the neural processing unit) may include a hardware structure specified for artificial intelligence model processing. An artificial intelligence model may be generated by machine learning. Such learning may be performed, e.g., by the electronic device 1101 where the artificial intelligence is performed or via a separate server (e.g., the server 1108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input module 1150 may receive a command or data to be used by another component (e.g., the processor 1120) of the electronic device 1101, from the outside (e.g., a user) of the electronic device 1101. The input module 1150 may include, for example, a microphone, a mouse, a keyboard, a key (e.g., a button), or a digital pen (e.g., a stylus pen).

The sound output module 1155 may output sound signals to the outside of the electronic device 1101. The sound output module 1155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1160 may visually provide information to the outside (e.g., a user) of the electronic device 1101. The display module 1160 may include, for example, a display, a hologram device, or a projector and control circuitry to control a corresponding one of the display, hologram device, and projector. According to an embodiment, the display module 1160 may include a touch sensor adapted to detect a touch, or a pressure sensor adapted to measure the intensity of force incurred by the touch.

The audio module 1170 may convert a sound into an electrical signal and vice versa. According to an embodiment, the audio module 1170 may obtain the sound via the input module 1150, or output the sound via the sound output module 1155 or a headphone of an external electronic device (e.g., an electronic device 1102) directly (e.g., wiredly) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. According to an embodiment, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device (e.g., the electronic device 1102) directly (e.g., wiredly) or wirelessly. According to an embodiment, the interface 1177 may include, for example, a high definition multimedia interface (HDMI), a universal serial bus (USB) interface, a secure digital (SD) card interface, or an audio interface.

A connecting terminal 1178 may include a connector via which the electronic device 1101 may be physically connected with the external electronic device (e.g., the electronic device 1102). According to an embodiment, the connecting terminal 1178 may include, for example, a HDMI connector, a USB connector, a SD card connector, or an audio connector (e.g., a headphone connector).

The haptic module 1179 may convert an electrical signal into a mechanical stimulus (e.g., a vibration or a movement) or electrical stimulus which may be recognized by a user via his tactile sensation or kinesthetic sensation. According to an embodiment, the haptic module 1179 may include, for example, a motor, a piezoelectric element, or an electric stimulator.

The camera module 1180 may capture a still image or moving images. According to an embodiment, the camera module 1180 may include one or more lenses, image sensors, image signal processors, or flashes.

The power management module 1188 may manage power supplied to the electronic device 1101. According to one embodiment, the power management module 1188 may be implemented as at least part of, for example, a power management integrated circuit (PMIC).

The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the application processor (AP)) and supports a direct (e.g., wired) communication or a wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as Bluetooth™ wireless-fidelity (Wi-Fi) direct, or infrared data association (IrDA)) or the second network 1199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The wireless communication module 1192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., the millimeter wave (mmWave) band) to achieve, e.g., a high data transmission rate. The wireless communication module 1192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1192 may support various requirements specified in the electronic device 1101, an external electronic device (e.g., the electronic device 1104), or a network system (e.g., the second network 1199). According to an embodiment, the wireless communication module 1192 may support a peak data rate (e.g., 20 Gbps or more) for implementing eMBB, loss coverage (e.g., 1164 dB or less) for implementing mMTC, or user plane (U-plane) latency (e.g., 0.5 ms or less for each of downlink (DL) and uplink (UL), or a round trip of 11 ms or less) for implementing URLLC.

The antenna module 1197 may transmit or receive a signal or power to or from the outside (e.g., the external electronic device) of the electronic device 1101. According to an embodiment, the antenna module 1197 may include an antenna including a radiating element composed of a conductive material or a conductive pattern formed in or on a substrate (e.g., a printed circuit board (PCB)). According to an embodiment, the antenna module 1197 may include a plurality of antennas (e.g., array antennas). In such a case, at least one antenna appropriate for a communication scheme used in the communication network, such as the first network 1198 or the second network 1199, may be selected, for example, by the communication module 1190 (e.g., the wireless communication module 1192) from the plurality of antennas. The signal or the power may then be transmitted or received between the communication module 1190 and the external electronic device via the selected at least one antenna. According to an embodiment, another component (e.g., a radio frequency integrated circuit (RFIC)) other than the radiating element may be additionally formed as part of the antenna module 1197.

According to various embodiments, the antenna module 1197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1101 and the external electronic device 1104 via the server 1108 coupled with the second network 1199. Each of the electronic devices 1102 or 1104 may be a device of a same type as, or a different type, from the electronic device 1101. According to an embodiment, all or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To that end, a cloud computing, distributed computing, mobile edge computing (MEC), or client-server computing technology may be used, for example. The electronic device 1101 may provide ultra low-latency services using, e.g., distributed computing or mobile edge computing. In another embodiment, the external electronic device 1104 may include an internet-of-things (IoT) device. The server 1108 may be an intelligent server using machine learning and/or a neural network. According to an embodiment, the external electronic device 1104 or the server 1108 may be included in the second network 1199. The electronic device 1101 may be applied to intelligent services (e.g., smart home, smart city, smart car, or healthcare) based on fifth generation (5G) communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1140) including one or more instructions that are stored in a storage medium (e.g., internal memory 1136 or external memory 1138) that is readable by a machine (e.g., the electronic device 1101). For example, a processor (e.g., the processor 1120) of the machine (e.g., the electronic device 1101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a communication circuit configured to receive and transmit a signal;
memory, including one or more storage media, storing one or more computer programs and at least one application; and
one or more processors communicatively coupled to the communication circuit and the memory,
wherein the one or more computer programs include computer-executable instructions that, when executed by the one or more processors individually or collectively, cause the electronic device to:
based on a request for a cloud service associated with a first application received from an external device through the communication circuit, execute the first application corresponding to the request for the cloud service among the at least one application,
while executing the first application, recognize a request for an action associated with a second application from the first application, and
based on a determination that target information included in the request for the action corresponds to target information related to a pre-designated deep link, transmit the request for the action to the external device.

2. The electronic device of claim 1,
wherein the one or more computer programs further include computer-executable instructions that, when executed by the one or more processors individually or collectively, cause the electronic device to:
receive redirect information corresponding to the request for the action from the external device through the communication circuit,
based on a determination that the redirect information is related to the first application, provide the redirect information to the first application, and
perform an action of the first application based at least in part on the redirect information, and
wherein the redirect information is generated through an application different from the first application included in the external device.

3. The electronic device of claim 2, wherein the one or more computer programs further include computer-executable instructions that, when executed by the one or more processors individually or collectively, cause the electronic device to determine whether the redirect information is related to the first application based on whether target information included in the redirect information corresponds to predetermined setting information associated with the first application.

4. The electronic device of claim 3, wherein the request for the action includes at least one of the target information corresponding to the action or uniform resource identifier (URI) information related to the action.

5. The electronic device of claim 1, wherein the request for the action includes at least one of the target information corresponding to the action or uniform resource identifier (URI) information related to the action.

6. An electronic device, comprising:
a display;
a communication circuit configured to receive and transmit a signal;
memory, including one or more storage media, storing one or more computer programs and at least one application; and
one or more processors communicatively coupled to the display, the communication circuit, and the memory,
wherein the one or more computer programs include computer-executable instructions that, when executed by the one or more processors individually or collectively, cause the electronic device to:
request a cloud service associated with a first application from an external device through the communication circuit,
receive, from the external device, cloud service data related to the first application executed by the external device,
display an execution screen of the first application through the display based on the cloud service data,
receive, from the external device, a request for an action associated with a second application from the first application while displaying the execution screen of the first application,
execute the second application corresponding to the request for the action among the at least one application, and
perform the action through the second application.

7. The electronic device of claim 6, wherein the one or more computer programs further include computer-executable instructions that, when executed by the one or more processors individually or collectively, cause the electronic device to:
receive a user input associated with an execution of the action;
generate redirect information associated with the request for the action through the second application based at least in part on the user input; and
transmit the redirect information to the external device through the communication circuit.

8. The electronic device of claim 6, wherein the one or more computer programs further include computer-executable instructions that, when executed by the one or more processors individually or collectively, cause the electronic device to display an execution result of the action through the display.

9. The electronic device of claim 6, wherein the one or more computer programs further include computer-executable instructions that, when executed by the one or more processors individually or collectively, cause the electronic device to determine the second application among the at least one application based on target information included in the request for the action.

10. The electronic device of claim 6, wherein the one or more computer programs further include computer-executable instructions that, when executed by the one or more processors individually or collectively, cause the electronic device to:
provide a user interface for determining the second application among the at least one application based on identifying a plurality of applications corresponding to target information included in the request for the action among the at least one application; and
determine the second application based on a user input received through the user interface.

11. The electronic device of claim 6, wherein the execution screen of the first application includes an indication indicating that the first application is being executed based on the cloud service.

12. A method of an electronic device for providing a cloud service, comprising:
based on a request for a cloud service associated with a first application received from an external device, executing the first application corresponding to the request for the cloud service;
while executing the first application, recognizing a request for an action associated with a second application from the first application; and
based on a determination that target information included in the request for the action corresponds to target information related to a pre-designated deep link, transmitting the request for the action to the external device.

13. The method of claim 12, further comprising:
receiving redirect information corresponding to the request for the action from the external device;
based on a determination that the redirect information is related to the first application, providing the redirect information to the first application; and
performing an action of the first application based at least in part on the redirect information,
wherein the redirect information is generated through an application different from the first application included in the external device.

14. The method of claim 13, wherein the providing of the redirect information to the first application includes determining whether the redirect information is related to the first application based on whether target information included in the redirect information corresponds to predetermined setting information associated with the first application.

15. The method of claim 12, wherein the request for the action includes at least one of the target information corresponding to the action or uniform resource identifier (URI) information related to the action.

16. A method of an electronic device for providing a cloud service, the method comprising:
requesting a cloud service associated with a first application from an external device;
receiving cloud service data associated with the first application executed by the external device from the external device;
displaying an execution screen of the first application through a display of the electronic device based on the cloud service data;
receiving, from the external device, a request for an action associated with a second application from the first application while displaying the execution screen of the first application;
executing the second application corresponding to the request for the action among at least one application stored on the electronic device; and
performing the action through the second application.

17. The method of claim 16, further comprising:
receiving a user input associated with the performing of the action;
generating redirect information associated with the request for the action through the second application based at least in part on the user input; and
transmitting the redirect information to the external device.

18. The method of claim 16, further comprising displaying an execution result of the action through the display.

19. The method of claim 16, further comprising:
providing a user interface for determining the second application among the at least one application based on identifying a plurality of applications corresponding to target information included in the request for the action among the at least one application; and
determining the second application based on a user input received through the user interface.

20. One or more non-transitory computer-readable storage media storing one or more computer programs including computer-executable instructions that, when executed by one or more processors of an electronic device individually or collectively, cause the electronic device to perform operations, the operations comprising:
requesting a cloud service associated with a first application from an external device;
receiving cloud service data associated with the first application executed by the external device from the external device;
displaying an execution screen of the first application through a display of the electronic device based on the cloud service data;
receiving, from the external device, a request for an action associated with a second application from the first application while displaying the execution screen of the first application;
executing the second application corresponding to the request for the action among at least one application stored on the electronic device; and
performing the action through the second application.
